(19) United States
(12) Patent Application Publication
(10) Pub. No.: US 2022/0066846 A1
(43) Pub. Date: Mar. 3, 2022

(54) METHOD FOR AGGREGATING NOTIFICATION MESSAGES, AND ELECTRONIC DEVICE

(71) Applicant: BEIJING DAJIA INTERNET INFORMATION TECHNOLOGY CO., LTD., Beijing (CN)

(72) Inventor: Songyu LIANG, Beijing (CN)

(21) Appl. No.: 17/462,265

(22) Filed: Aug. 31, 2021

(30) Foreign Application Priority Data
Sep. 1, 2020 (CN) 202010905838.0

(51) Int. Cl. G06F 9/54; G06F 9/48; G06Q 10/10

(52) U.S. Cl. CPC G06F 9/546; G06Q 10/107; G06F 9/542; G06F 9/4881

(57) ABSTRACT

A method for aggregating notification messages, and an electronic device. The method includes: receiving at least one notification message; obtaining a task identifier of a task to which each notification message belongs; obtaining notification messages belonging to a same task based on the task identifiers; and aggregating and displaying the notification messages belonging to the same task.

### CROSS-REFERENCE TO RELATED APPLICATIONS

This disclosure claims priority to and benefits of Chinese Patent Application Serial No. 202010905838.0, filed on Sep. 1, 2020, the entire content of which is incorporated herein by reference for all purposes.

### TECHNICAL FIELD

The disclosure relates to data processing and software application technologies, and specifically relates to a method for aggregating notification messages, and an electronic device.

### BACKGROUND

With the rapid development of Internet and mobile terminal technology, project management products with various functions have emerged. In project management products, there are often multiple tasks, each of which produces multiple notification messages.

### SUMMARY

In a first aspect, a method for aggregating notification messages is provided. The method includes: receiving at least one notification message; obtaining a task identifier of a task to which each notification message belongs; obtaining notification messages belonging to a same task based on the task identifiers; and aggregating and displaying the notification messages belonging to the same task.

In another aspect, an electronic device is provided. The apparatus includes a processor and a memory configured to store instructions executable by the processor. The processor is configured to implement the method in the first aspect by reading and executing the instructions stored in the memory.

In a third aspect, a non-transitory computer readable storage medium is provided. The storage medium is stored thereon with instructions that, when executed by a processor of an electronic device, cause the electronic device to implement the method in the first aspect.

### BRIEF DESCRIPTION OF THE DRAWINGS

FIG. 1 is a flowchart of a method of aggregating notification messages according to an embodiment.

FIG. 2 is a schematic diagram of a notification message according to an embodiment.

FIG. 3 is a schematic diagram of displaying notification messages according to an embodiment.

FIG. 4 is a schematic diagram of displaying notification messages according to another embodiment.

FIG. 5 is a flowchart of a method of aggregating notification messages according to another embodiment.

FIG. 6 is a schematic diagram of displaying notification messages according to another embodiment.

FIG. 7 is a schematic diagram of displaying notification messages according to another embodiment.

FIG. 8 is a schematic diagram of viewing notification messages according to an embodiment.

FIG. 9 is a schematic diagram of hiding notification messages according to an embodiment.

FIG. 10 is a flowchart of a method for aggregating notification messages according to another embodiment.

FIG. 11 is a schematic diagram illustrating a display order of notification messages according to an embodiment.

FIG. 12 is a schematic diagram illustrating another display order of notification messages according to an embodiment.

FIG. 13 is a flowchart of a method for aggregating notification messages according to another embodiment.

FIG. 14 is a schematic diagram of a task focus control according to an embodiment.

FIG. 15 is a schematic diagram of displaying notification messages according to another embodiment.

FIG. 16 is a schematic diagram of displaying notification messages according to another embodiment.

FIG. 17 is a schematic diagram of displaying notification messages according to another embodiment.

FIG. 18 is a flowchart of a method for aggregating notification messages according to another embodiment.

FIG. 19 is a flowchart of a method for aggregating notification messages according to another embodiment.

FIG. 20 is a flowchart of a method for aggregating notification messages according to another embodiment.

FIG. 21 is a block diagram of an apparatus for aggregating notification messages according to an embodiment.

FIG. 22 is a block diagram of an apparatus for aggregating notification messages according to an embodiment.

FIG. 23 is a schematic diagram of an electronic device according to an embodiment.

### DETAILED DESCRIPTION

In order to enable ordinary skilled in the art to better understand the technical solutions in this disclosure, the technical solutions in embodiments of this disclosure will be clearly and completely described in combination with the attached drawings below.

It should be noted that terms “first”, “second”, etc., in the specification and claims of the disclosure and in the appended drawings are used to distinguish similar objects and need not be used to describe a particular order or sequence. It should be understood that the data so used are interchangeable, where appropriate, so that embodiments of this disclosure described here may be implemented in a sequence other than those illustrated or described here. The implementations described in the following embodiments do not represent all implementations consistent with this disclosure. Rather, they are merely examples of devices and methods consistent with some aspects of this disclosure as detailed in the attached claims.

With the rapid development of Internet and mobile terminal technology, project management products with various functions have emerged. In project management products, there are often multiple tasks, each of which produces multiple notification messages.

When the number of tasks is large, a large number of notification message are generated accordingly. In the related art, every time a user wants to view notification messages of a certain task, due to the large number of notification messages, the user needs to perform other operations to obtain the desired notification messages from the large number of notification messages, which will inevitably lead to low view efficiency.

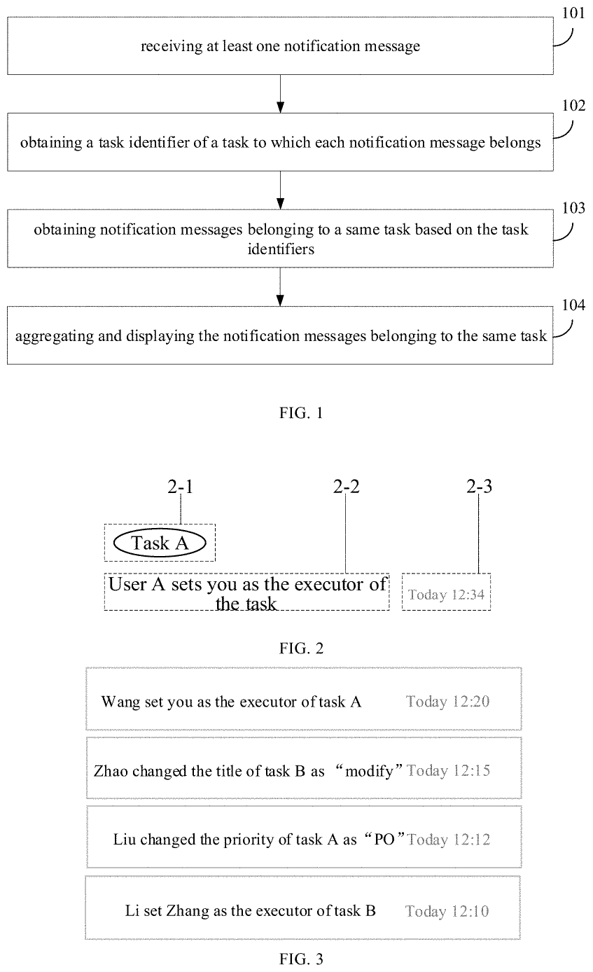

FIG. 1 is a flowchart of a method for aggregating notification messages according to an embodiment. In some embodiments, the method may be applied to a terminal device provided with project management products. The terminal device may be, but not limited to, a personal computer or a handheld terminal. As illustrated FIG. 1, the method may include following steps.

At step 101, at least one notification message is received.

In embodiments of this disclosure, the related personnel may log in the project management products through the terminal device to achieve creation, management and editing of projects and tasks. The related personnel may be the creator of the task, the executor of the task, and so on. The notification message is a message generated by a task which is managed by a project management product, and the notification message is configured to notify the personnel related to the task of dynamics of the task which has changed. Generally, when any task is operated, one notification message of the task will be generated. For example, any operation event, such as changing the priority or the title of the task, or creating a sub-task under the task, will trigger generating the notification message of the task.

The notification message includes at least a task identifier of the task to which the notification message belongs, a task content and a notification time.

For example, as illustrated in FIG. 2, the notification message includes the task identifier 2-1, the task content 2-2 and the notification time 2-3.

At step 102, the task identifier of the task to which each notification message belongs is obtained.

Since the notification message includes the task identifier of the task to which the notification message belongs., in embodiments of this disclosure, the task identifier of the task to which each notification message belongs may be extracted from each received notification message.

The task identifier may be configured to indicate the task to which the notification message belongs. For example, there are three tasks, which are identified as task A, task B, and task C. A, B and C are identifiers of task A, task B and task C respectively. The tasks to which the notification messages belong are distinguished by identifiers A, B, and C.

At step 103, notification messages belonging to a same task are obtained based on the task identifiers.

Notification messages with consistent task identifiers belong to the same task. Therefore, in embodiments of this disclosure, notification messages belonging to the same task may be identified by judging whether the obtained task identities are consistent. For example, there are six notification messages, where notification message 1 carries task identifier A, notification message 2 carries task identifier B, notification message 3 carries task identifier C, notification message 4 carries task identifier A, notification message 5 carries task identifier C, and notification message 6 carries task identifier B. Based on the task identifier of each notification message, it may be determined that notification messages 1 and 4 belong to task A, notification messages 2 and 6 belong to task B, and notification messages 3 and 5 belong to task C.

At step 104, the notification messages belonging to the same task are aggregated and displayed.

The notification messages belonging to the same task are generated due to the dynamic change of the same task. Therefore, in order to enable the related personnel to view all dynamic changes of the task at once, in embodiments of this disclosure, the notification messages belonging to the same task may be aggregated, and the aggregated notification messages are loaded to a display interface, to realize displaying aggregated notification messages. That is, notification messages for the same task may be aggregated together to display, for example, in a message card, or a message group, and displayed on the display interface. The display interface used to display notification messages is not limited in this disclosure, and may be selected according to the actual situation.

In the related art, notification time is usually used as the basis for the display order of notification messages. For example, as shown in FIG. 3, although the first notification message and the third notification message belong to task A, and the second notification message and the fourth notification message belong to task B, the notification messages for the same task will be displayed separately due to different notification time and other reasons. In this way, users often receive massive and scattered notification messages. Users need to rely on search and other methods to obtain the relevant notification messages, the process of which takes a long time, and which is not good for users to quickly obtain highly relevant notification messages, so that users cannot grasp the context of the same task in time.

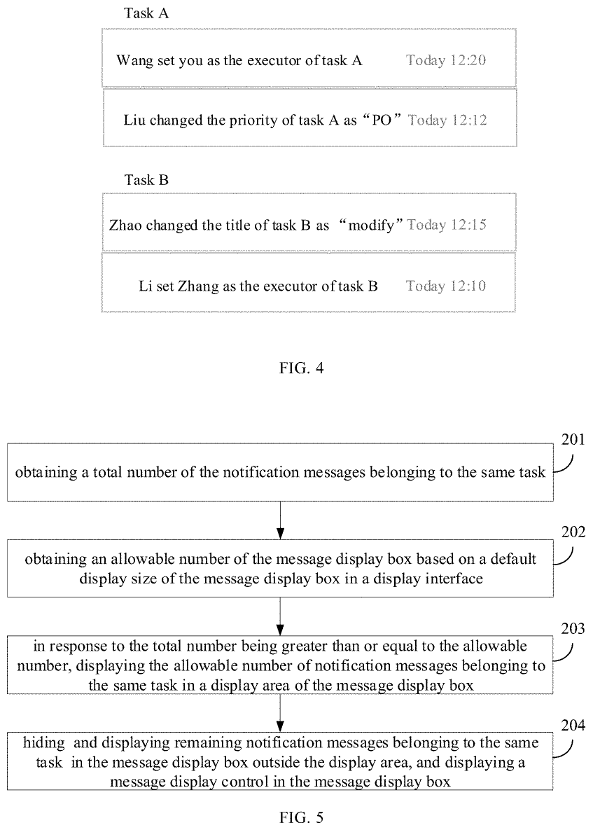

In embodiments of this disclosure, after the notification messages belonging to the same task are obtained, the notification messages belonging to the same task may be aggregated and displayed. FIG. 4 shows a schematic diagram of the notification message aggregation. The first notification message and the third notification message belong to task A, then the first and third notification messages may be aggregated and displayed on the message card of task A. The second notification message and the fourth notification message belong to task B, then the second and fourth notification message may be aggregated and displayed on the message card of task B.

In this disclosure, the highly correlated notification messages belonging to the same task are aggregated and displayed, so that users no longer rely on search to obtain the relevant notification messages from the massive and scattered notification messages, ensuring that users can quickly view the relevant notification messages of the same task, reducing the time consumed by viewing notification messages, and improving the efficiency of viewing messages.

It is to be noted that, in this disclosure, when notification messages belonging to the same task are to be aggregated, notification messages belonging to the same task may be aggregated into the message display box of the same task for display. It is to be noted that, when the aggregated notification messages of the same task are to be displayed, the notification messages belonging to the same task may be displayed in the message display box of the same task in the order of notification time from late to early.

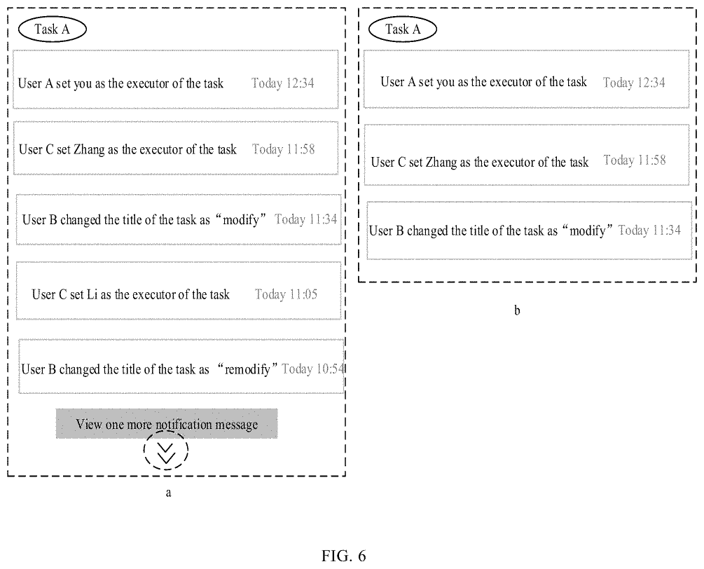

As a possible implementation, as illustrated in FIG. 5, on the basis of above embodiments, the process of aggregating the notification messages belonging to the same task into the message display box of the same task for display may include following steps.

At step 201, a total number of the notification messages belonging to the same task is obtained.

At step 202, an allowable number of the message display box is obtained based on a default display size of the message display box in a display interface.

Generally, the display interface is an interface of a project management product displayed on a display screen of the terminal device. The message display box is displayed in the display interface. In this disclosure, the default display size may be configured in advance for the message display box of each task, and different default display sizes always allow different numbers of notification messages to be displayed. In embodiments of this disclosure, optionally, the default display size of the message display box under the display interface may be obtained, and according to the default display size of the message display box under the display interface and the display size of the notification message, the allowable number of the message display box under the default display size may be obtained. For example, the default display size of the message display box in the display interface is 55 mm×55 mm, and the display size of the notification message is 10 mm×50 mm, then the allowable number of the message display box under the default display size is 5. That is, up to 5 notification messages may be displayed for each task.

At step 203, in response to the total number being greater than or equal to the allowable number, the allowable number of notification messages belonging to the same task are displayed in a display area of the message display box.

In embodiments of this disclosure, after the total number and the allowable number are obtained, it may be determined whether the total number is greater than the allowable number. If the total number is equal to or greater than the allowable number, it indicates that the number of notification messages belonging to the same task is greater than the number of notification messages that are allowed to be displayed, then only the allowable number of notification messages belonging to the same task may be displayed in the display area of the message display box. If the total number is smaller than the allowable number, it indicates that the number of notification messages belonging to the same task is smaller than the number of notification message that are allowed to be displayed, then all notification messages belonging to the same task may be displayed in the display area oaf the message display box. Optionally, the default display size of the message display box for the same task may be reduced when the total number is smaller than the allowable number.

For example, as shown in FIG. 6 (a), the allowable number is 5, and there are 6 notification messages belonging to the same task, then 5 notification messages are displayed in message display box 1. As shown in FIG. 6 (b), the allowable number is 5, and there are 3 notification messages belonging to the same task, then 3 notification messages are displayed in message display box 1. In this case, the actual display area of 5 notification messages is larger than that of 3 notification messages.

At step 204, remaining notification messages belonging to the same task are hidden and displayed in the message display box outside the display area, and a message display control is displayed in the message display box.

In embodiments of this disclosure, when the total number of notification messages is greater than or equal to the allowable number, the allowable number of notification messages belonging to the same task may be displayed in the display area of the message display box, and the remaining notification messages belonging to the same task may be hidden and displayed in the message display box outside the display area, so that notification messages of as many tasks as possible may be displayed when the notification messages are aggregated and displayed.

Further, when the user attempts to view a notification message that is hidden, a first trigger operation may be performed, that is, by triggering the message display control. Accordingly, in response to the first trigger operation on the message display control, the display size of the message display box in the display interface may be adjusted until the remaining notification messages can be displayed completely, and then the hidden notification messages are displayed in the display area of the message display box.

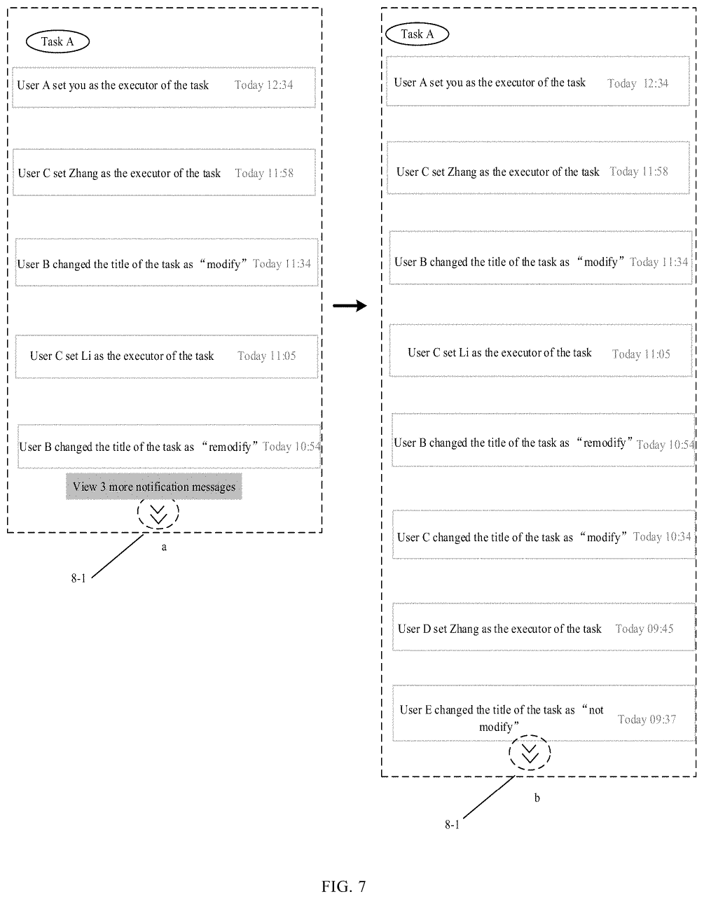

For example, as illustrated in FIG. 7 (a), the total number of messages is greater than the allowable number, and thus five notification messages are displayed in the display area of the message display box. When the user attempts to view the hidden notification messages, the first trigger operation may be performed by triggering the message display control 8-1 as shown in FIG. 7 (a), and at this time, the remaining three hidden notification messages will be displayed, as shown in FIG. 7 (b), for the user to view.

Note that the display size of the message display box may be determined according to the total number of messages and the size of the display interface. If the total number of messages exceeds the allowable number of the message display box under a maximum display size, i.e., a maximum display number, the user may view the messages by moving a slider.

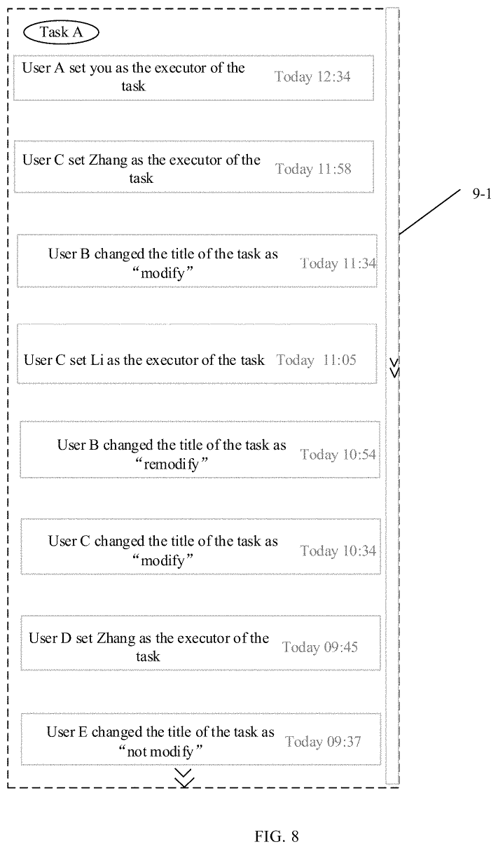

For example, as shown in FIG. 8, when the total number of messages exceeds the maximum display number of the message display box, the user may view the messages by moving the slider 9-1.

Further, when the user has finished viewing the hidden notification message and tries to hide the hidden notification message again, a second trigger operation may be performed, that is, by triggering the message display control again. Accordingly, in response to the second trigger operation on the message display control, the message display box is restored to its default display size and the previously hidden notification messages are hidden and displayed in the message display box outside the display area again.

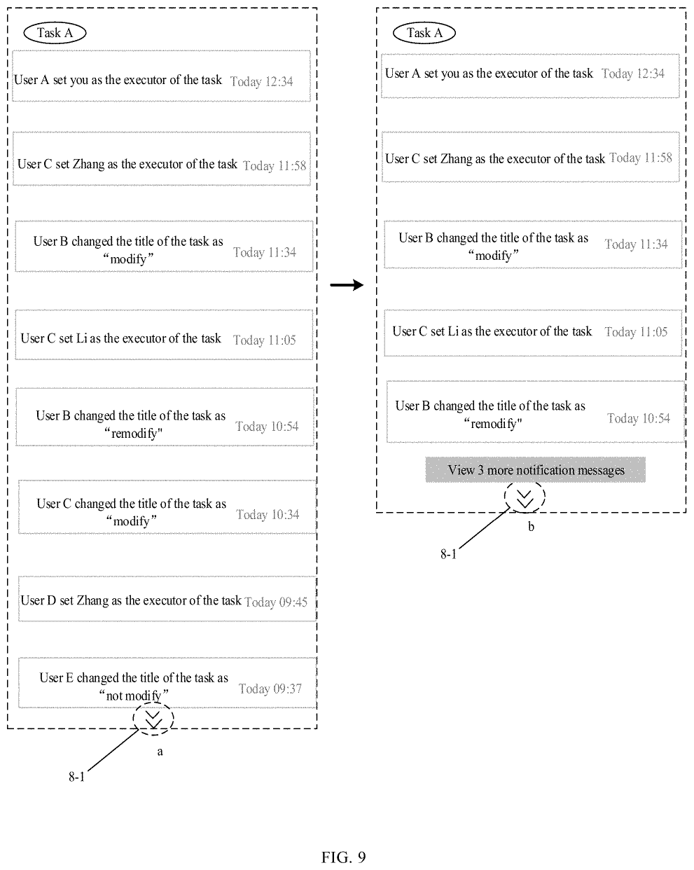

For example, as shown in FIG. 9 (a), when the user has finished viewing the hidden notification message and tries to hide the hidden notification message again, the user may perform the second trigger operation by triggers the message display control 8-1 shown in FIG. 9 (a) again, and at this time, the remaining three notification messages are hidden again, as shown in FIG. 9 (b).

It should be noted that, in this disclosure, the specific way of identifying the first trigger operation and the second trigger operation is not limited, which may be selected according to the actual situation. For example, a first cumulative number of times that the message display control has been triggered may be obtained. If the first number of times is odd, the current trigger operation is identified as the first triggered operation. If the first number of times is even, the current trigger operation is identified as the second trigger operation.

In this disclosure, by obtaining the total number of notification message belonging to the same task, and obtaining the allowable number of the message display box under the default display size according to the default display size of the message display box in the display interface, and further displaying the notification messages belonging to the same task according to the allowable number, and hiding the remaining notification messages, notification messages of as many tasks as possible may be displayed when the notification messages are aggregated and displayed. Further, in this disclosure, by adding the message display control, and by responding to the first and second trigger operations, the hidden notification messages may be displayed to the user according to actual needs, and may be hidden again after the user's viewing, which may satisfy different needs of the user, improve the adaptability of the , and further improve the user's reading experience.

It should be noted that, since the message display boxes of multiple tasks may be displayed in the display interface at the same time, after aggregating the notification message belonging to the same task into the message display box of the same task for display, the latest notification time of the task may be obtained, and the display order of the display message boxes may be determined according to the latest notification time, so that notification messages of multiple tasks may be displayed in the display interface at the same time.

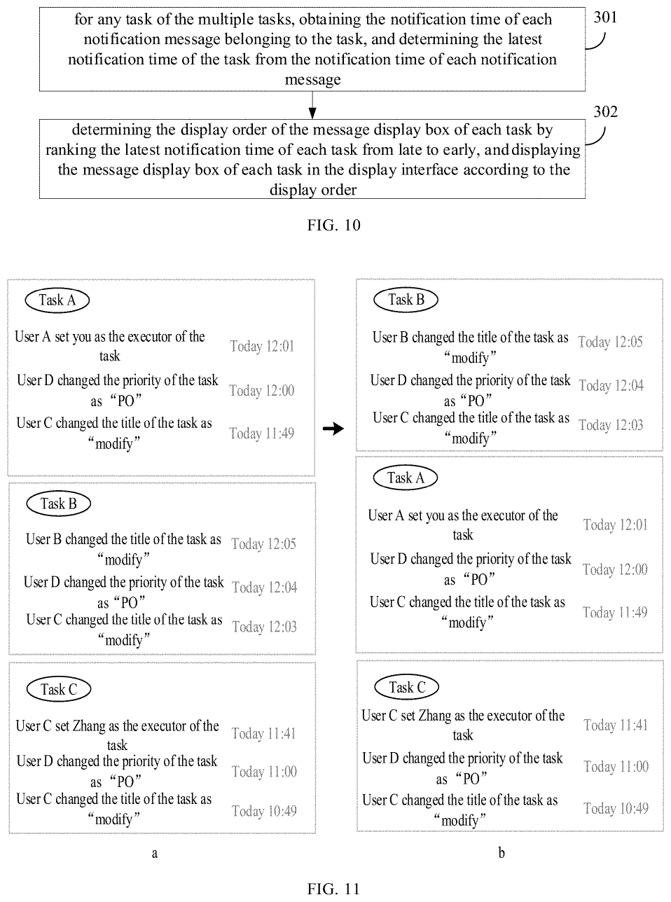

As a possible implementation, as illustrated in FIG. 10, on the basis of above embodiments, the process of determining the display order of the message display boxes according to the latest notification time may include following steps.

At step 301, for any task of the multiple tasks, the notification time of each notification message belonging to the task is obtained, and the latest notification time of the task is determined from the notification time of each notification message.

The latest notification time refers to the notification time of the latest notification received for the task.

For example, for task A, only one notification message is sent, and the notification time of the notification message is 12:01, then the latest notification time of task A is 12:01; for task B, two notification messages are sent, one is sent at 12:05, and the other one is sent at 12:01, then the latest notification time of task B is 12:05.

At step 302, the display order of the message display box of each task is determined by ranking the latest notification time of each task from late to early, and the message display box of each task is displayed in the display interface according to the display order.

For example, as shown in FIG. 11 (a), the notification time of the latest notification message in task A is 12:01, the notification time of the latest notification message in task B is 12:05, and the notification time of the latest notification message in task C is 11:41, then in this case, as shown in FIG. 11 (b), the display order may be task B, task A, task C.

It should be noted that, every time a new notification message is received, the target task to which the new notification message belongs is determined, and the message display box of the target task may be updated to be displayed at the first place of the display interface.

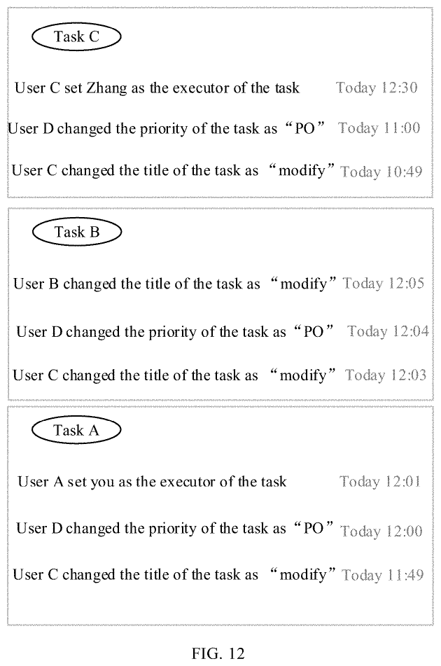

For example, as shown in FIG. 12, on the basis of above embodiments, the notification time of a latest notification message received for task C is 12:30, and then the display order is updated as task C, task B, task A.

In this disclosure, by obtaining the notification time of each notification message belonging to each task, and determining the latest notification time of each task, the display order of the message display box of each task may be determined according to the latest notification time of each task from late to early, and the message display box of each task may be displayed in the display interface according to the display order, so that the user can know the latest notification message in time, which further improves the user's reading experience.

In embodiments of the disclosure, based on different concern degrees of the user about different tasks, a task concern control may be added when the aggregated notification messages are displayed, so that the display of the aggregated notification messages may be optimized.

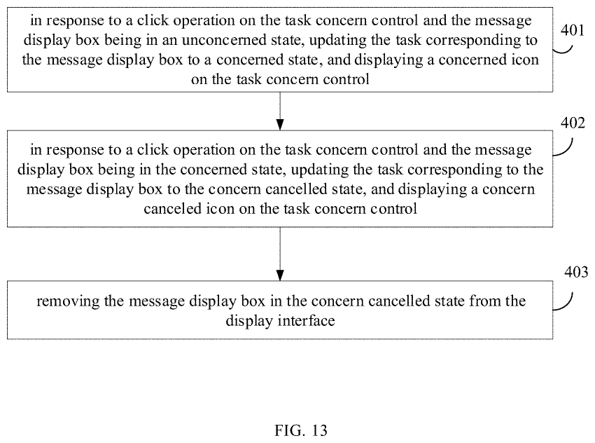

As a possible implementation, as illustrated in FIG. 13, on the basis of above embodiments, following steps may be performed.

At step 401, in response to a click operation on the task concern control and the message display box being in an unconcerned state, the task corresponding to the message display box is updated to a concerned state, and a concerned icon is displayed on the task concern control.

In embodiments of the disclosure, a task concern control is set in the message display box. When the user tries to pay special attention to the notification messages of any task, he can click the corresponding task concern control. Accordingly, after the user clicks on the task concern control, the terminal device detects the click operation on the task concern control.

The number of task concern controls may be the same as the number of tasks.

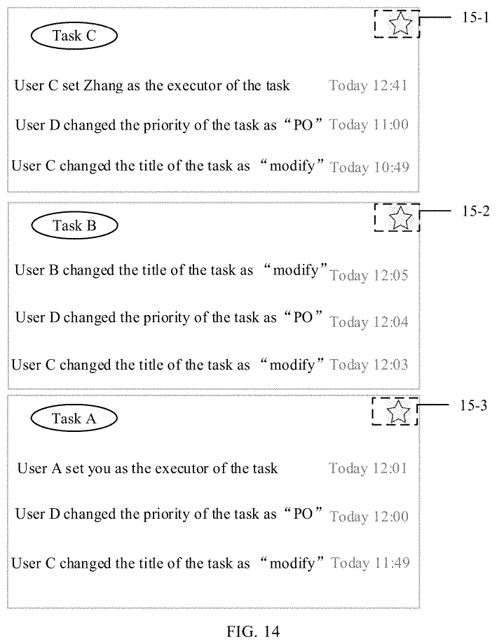

For example, as shown in FIG. 14, the aggregated notification messages of three tasks are displayed. In this case, task concern controls 15-1 to 15-3 are respectively set in the message display box of each task.

At step 402, in response to a click operation on the task concern control and the message display box being in the concerned state, the task corresponding to the message display box is updated to the concern cancelled state, and a concern canceled icon is displayed on the task concern control.

In embodiments of the disclosure, in response to the click operation on the task concern control, the target operation of the user may be identified by determining the state of the message display box. The target operation includes paying attention to notification messages of the corresponding task and cancelling attention to notification messages of the corresponding task.

When the message display box is currently in the unconcerned state, it indicates that target operation of the user is triggering task concern, and then the task corresponding to the message display box is updated as the concerned state, and the concerned icon is displayed on the task concern control. When the message display box is currently in the concerned state, it indicates that the target operation of the user is cancelling task concern, and then the task corresponding to the message display box is updated as the concern cancelled state, and the concern cancelled icon is displayed on the task concern control.

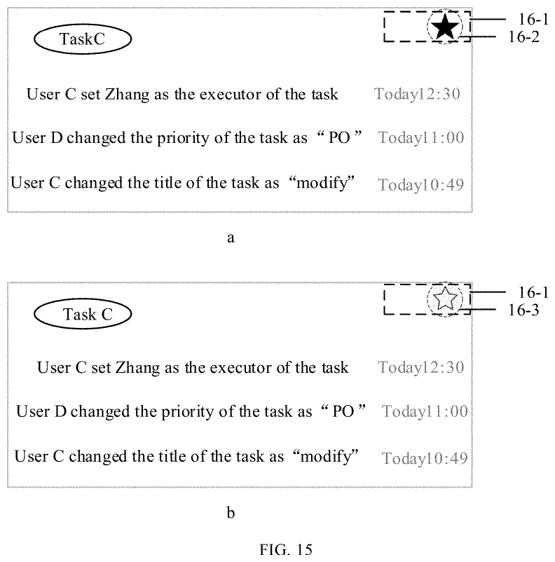

For example, as shown in FIG. 15, when the message display box is currently in the unconcerned state, in response to detecting the task concern operation, as shown in FIG. 15 (a), the task corresponding to message display box is updated as the concerned state, and the concerned icon 16-2 is displayed on the task concern control 16-1. When the message display box is currently in the concerned state, it indicates that the target operation of the user is cancelling task concern, as shown in FIG. 15 (b), the task corresponding to the message display box may be updated as the concern cancelled state, and the concern cancelled icon 16-3 may be displayed on the task concern control 16-1. Displaying the concerned icon 16-2 may be implemented by lighting up or filling the color, and displaying the concern cancelled icon 16-3 may be implemented by darkening or removing the filled color.

At step 403, the message display box in the concern cancelled state is removed from the display interface.

In embodiments of the disclosure, in order to further improve the quality of content displayed in the message display boxes, after the task corresponding to the message display box is updated to the concern cancelled state and the concern cancelled icon is displayed on the task concern control, the message display box in the concern cancelled state may be removed from the display interface.

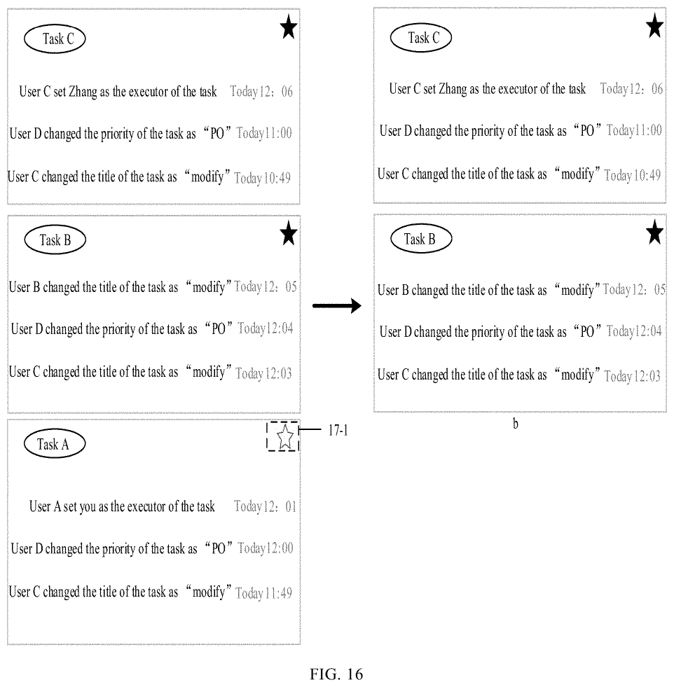

For example, the user may no longer participate in the task after participating in the task for a period of time, but the task will continue to send notification messages to the user. However, when the user does not need to pay attention to the task, the attention to the task may be cancelled, and then no notification message of the task will be received, which enables the user not to waste time reading the notification messages of the task. As shown in FIG. 16 (a), after updating task A corresponding to the message display box to the concern cancelled state and displaying the concern cancelled icon on the task concern control 17-1, as shown in FIG. 16 (b), the message display box in the concern cancelled state may be removed from the display interface, and only the notification messages of the remaining tasks are displayed, and the notification message of the task the concern of which is cancelled will no longer be received subsequently.

In other embodiments, when the user cancels concern to the task mistakenly or re-participates in the task, it indicates that the user needs to know dynamics of the task in real time, and in this case, the user needs to pay attention again to the task the concern of which is cancelled, and after concern, the message display box of the task may be re-displayed in the display interface, and the notification messages of the task may be re-received.

In this disclosure, after the task corresponding to the message display box is updated as the concern cancelled state, the message display box of the task the concern of which is cancelled may be re-displayed in the display interface in response to a renewed concern operation on the task the concern of which is cancelled. The renewed concern operation is generated when the task concern control in the message display box of the concern cancelled task in a history message queue is clicked again.

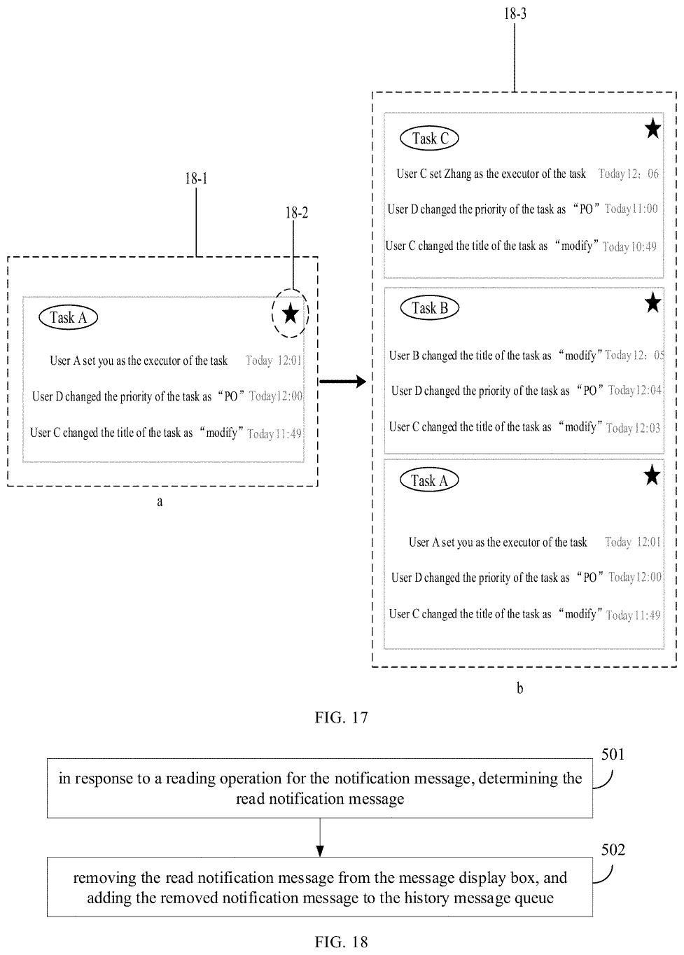

For example, as shown in FIG. 16, the user cancels concern to task A. Then, when the user needs to pay attention to the task again, as shown in FIG. 17, he may click on the task concern control 18-2 in the message display box of task A in the history message queue 18-1. The notification messages of task A may be displayed in the display interface 18-3 again.

In this disclosure, by adding the task concern control, the display of the aggregated notification messages may be optimized based on different concern degrees of the user about different tasks. Further, when the user tries to pay attention again to the notification messages of the task the concern of which is cancelled, the renewed concern operation may be performed in the history message queue, to recover the display of the notification messages of the task in the display interface, which improves the intelligent degree of displaying the aggregated notification messages, and further improves the user's reading experience.

It should be noted that, after the notification messages belonging to the same task are aggregated in to the message display box of the task for display, when a reading operation for the notification message is detected, the notification message is labelled as read.

As a possible implementation, as illustrated in FIG. 18, on the basis of above embodiments, following steps are included.

At step 501, in response to a reading operation for the notification message, the read notification message is determined.

In embodiments of the disclosure, when the user views the notification message, the reading operation may be performed. Accordingly, in response to the reading operation for the notification message, the read notification message may be determined according to the position of the reading operation.

It should be noted that, the user may perform the reading operation in various ways. For example, the user may perform the reading operation by swiping right the notification message of the task in the message display box. For another example, the user may perform the reading operation by double-clicking the notification message of the task in the message display box.

At step 502, the read notification message is removed from the message display box, and added to the history message queue.

In embodiments of the disclosure, after determining the read notification message, a message type of the read notification message is identified, and a matched display strategy is performed according to the message type. The message type may include a viewing message, for example, the notification message of an executor's change result, or an interaction message, for example, the notification message of whether agree with the executor's change result.

The following explains how to remove the read notification message from the message display box for viewing messages and interaction messages respectively.

For viewing messages, as a possible implementation, the message type of the read notification message may be obtained, and if the message type indicates that the read notification message is a viewing message, then the read notification message is removed from the message display box.

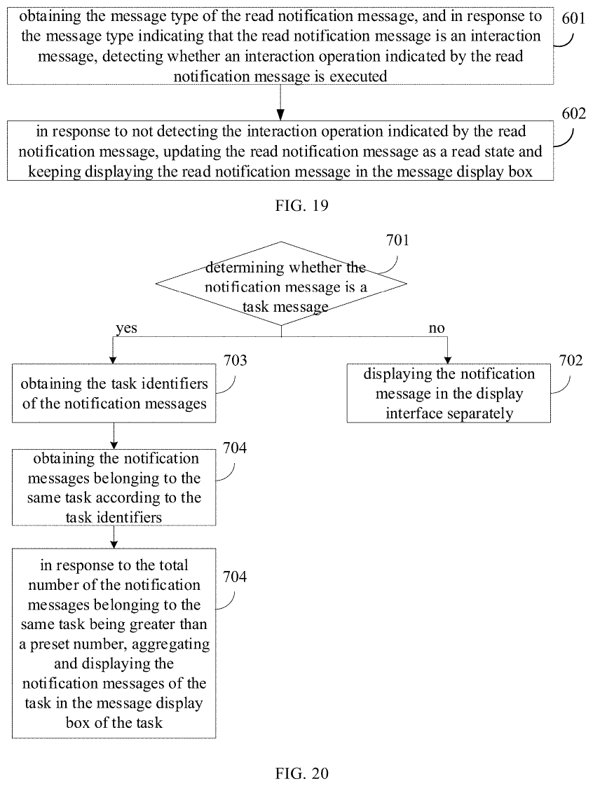

For interaction messages, as a possible implementation, as illustrated in FIG. 19, following steps are included.

At step 601, the message type of the read notification message is obtained, and in response to the message type indicating that the read notification message is an interaction message, whether an interaction operation indicated by the read notification message is executed is detected.

For example, the interaction message is whether agree with the executor's change result. For this type of notification message, the reading operation is only a link in the process of processing this type of notification message, and in this case, whether the interaction operation indicated by the read notification message is executed also needs to be monitored.

At step 602, in response to not detecting the interaction operation indicated by the read notification message, the read notification message is updated as a read state and still displayed in the message display box.

If no interaction operation is detected, it indicates that the process of processing this type of notification message is not completed, then the read notification message may be updated as the read state and still displayed in the message display box. If the interaction operation is detected, it indicates that the process of processing this type of notification message is completed, then the read notification message may be removed from the message display box and added into the history message queue.

In this disclosure, after the notification messages belonging to the same task are aggregated in to the message display box of the task for display, the user may perform the reading operation on the notification message, and matched display strategy may be performed by identifying the message type of the notification message on which the user performs the reading operation. In this way, the message viewing efficiency may be ensured, and the notification message may be avoided from being ignored due to mis-operations on the interaction message, which improves the intelligence degree of displaying the aggregated notification messages, and further improves the user's reading experience and message acquisition efficiency.

It should be noted that, before obtaining the task identifier of the task to which each notification message belongs, the message type of the received notification message may be identified, so that different display strategies may be performed according to different types.

As a possible implementation, as illustrated in FIG. 20, on the basis of above embodiments, following steps are included.

At step 701, whether the notification message is a task message is determined. If the notification message is identified as a non-task message, step 702 is executed. If the notification message is identified as a task message, step 703 is executed.

At step 702, the notification message is displayed in the display interface separately. If the notification message is identified as a non-task message, for example, a judge-type message, the notification message is displayed in the display interface separately, as a single message.

At step 703, the task identifiers of the notification messages are obtained.

At step 704, the notification messages belonging to the same task are obtained according to the task identifiers.

At step 705, in response to the total number of the notification messages belonging to the same task being greater than a preset number, the notification messages of the task are aggregated and displayed in the message display box of the task.

The preset number may be the allowable number under the default display size of the message display box, or may be a customized number.

In this disclosure, the highly correlated notification messages belonging to the same task are aggregated and displayed, so that users no longer rely on search to obtain the relevant notification messages from the massive and scattered notification messages, ensuring that users can quickly view the relevant notification messages of the same task, reducing the time consumed by viewing notification messages, and improving the efficiency of viewing messages.

In order to achieve above embodiments, the disclosure further provides an apparatus for aggregating notification messages.

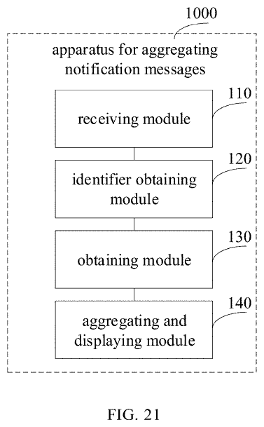

FIG. 21 is a block diagram of an apparatus for aggregating notification messages according to an embodiment. As illustrated in FIG. 21, the apparatus 1000 includes a receiving module 110, an identifier obtaining module 120, an obtaining module 130 and an aggregating and displaying module 140.

The receiving module 110 is configured to receive at least one notification message. The identifier obtaining module 120 is configured to obtain a task identifier of a task to which each notification message belongs.

The obtaining module 130 is configured to obtain notification messages belonging to a same task based on the task identifiers.

The aggregating and displaying module 140 is configured to aggregate and display the notification messages belonging to the same task.

In an embodiment of the present disclosure, the aggregating and displaying module 140 is configured to aggregate the notification messages belonging to the same task into a message display box of the task for display.

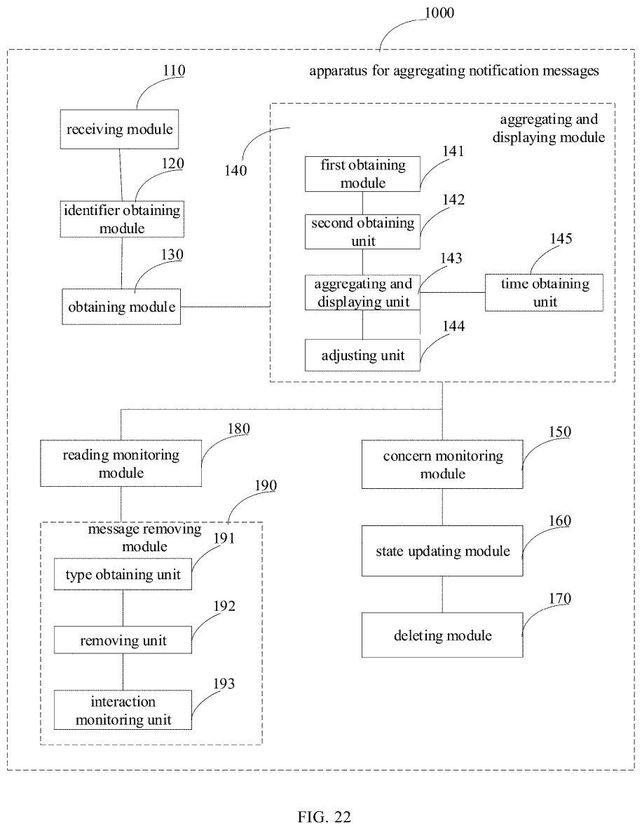

In an embodiment of the present disclosure, as illustrated in FIG. 22, the aggregating and displaying module 140 includes a first obtaining unit 141, a second obtaining unit 142, an aggregating and displaying unit 143.

The first obtaining unit 141 is configured to obtain a total number of the notification messages belonging to the same task.

The second obtaining unit 142 is configured to obtain an allowable number of the message display box based on a default display size of the message display box in a display interface.

The aggregating and displaying unit 143 is configured to, in response to the total number being greater than or equal to the allowable number, display the allowable number of notification messages belonging to the same task in a display area of the message display box, hiding and display remaining notification messages belonging to the same task in the message display box outside the display area, and display a message display control in the message display box.

In an embodiment, the aggregating and displaying module 140 further includes an adjusting unit 144.

The adjusting unit 144 is configured to, in response to a first trigger operation on the message display control, adjust a display size of the display area of the message display box, and display the hidden notification messages in the display area of the message display box ; and in response to a second trigger operation on the message display control, recover the display area of the message display box to the default display size, and hide the previously hidden notification messages again.

In an embodiment, the aggregating and displaying module 140 further includes a time obtaining unit 145.

The time obtaining unit 145 is configured to obtain a latest notification time of each task, in which the latest notification time of the task is a notification time of a latest notification message for the task.

The aggregating and displaying unit 143 is configured to determine a display order of the message display box of each task in the display interface according to the latest notification time of each task from late to early, and display the message display box of each task in the display interface according to the display order.

In an embodiment, the identifier obtaining module 120 is further configured to determine a target task to which a new notification message belongs.

The aggregating and displaying unit 143 is further configured to display the message display box of the target task at the first place of the display interface.

In an embodiment, the message display box includes a task concern control. The apparatus 1000 further includes a concern monitoring module 150, a state updating module 160, and a deleting module 170.

The concern monitoring module 150 is configured to monitor a click operation on the task concern control.

The state updating module 160 is configured to, in response to the message display box being in an unconcerned state and in response to a click operation on the task concern control, update the task corresponding to the message display box as a concerned state, and display a concerned icon on the task concern control; in response to the message display box being in a concerned state and in response to a click operation on the task concern control in the message display box, update the task corresponding to the message display box as a concern cancelled state, and display a concern cancelled icon on the task concern control.

The deleting module 170 is configured to, in response to detecting a close or refresh operation on the message display box of the task the concern of which is cancelled, remove the message display box of the task the concern of which is cancelled from the display interface.

The state updating module 160 is further configured to, in response to detecting a renewed concern operation on the task the concern of which is cancelled, re-display the message display box of the task the concern of which is cancelled in the display interface.

In an embodiment, the apparatus 1000 further includes a reading monitoring module 180 and a message removing module 190.

The reading monitoring module 180 is configured to determine a read notification message in response to detecting a reading operation for the notification message is detected.

The message removing module 190 is configured to remove the read notification message from the message display box and add the removed notification message into a history message queue.

In an embodiment, the message removing module 190 includes a type obtaining unit 191 and a removing unit 192.

The type obtaining unit 191 is configured to determine a message type of the read notification message.

The removing unit 192 is configured to remove the read notification message from the message display box in response to the message type indicating that the read notification message is a viewing message.

In an embodiment, the message removing module 190 further includes an interaction monitoring unit 193.

The interaction monitoring unit 193 is configured to, in response to the message type indicating that the read notification message is an interaction message, and in response to not detecting an interaction operation indicated by the read notification message, update a state of the read notification message as a read state, and keep displaying the read notification message in the message display box.

In an embodiment, the aggregating and displaying module 140 is further configured to, in response to the notification message being a non-task message, display the notification message in the display interface separately; and in response to the notification message being a task message, obtain the task identifier of the notification message.

In an embodiment, the aggregating and displaying module 140 is configured to display the notification message belonging to the same task in the message display box of the task according to a notification time from late to early.

In this disclosure, the highly correlated notification messages belonging to the same task are aggregated and displayed, so that users no longer rely on search to obtain the relevant notification messages from the massive and scattered notification messages, ensuring that users can quickly view the relevant notification messages of the same task, reducing the time consumed by viewing notification messages, and improving the efficiency of viewing messages.

In order to implement the above embodiments, the present disclosure further provides an electronic device.

The electronic device includes a processor and a memory configured to store instructions executable by the processor. The processor is configured to implement the above method for aggregating notification messages by executing the instructions.

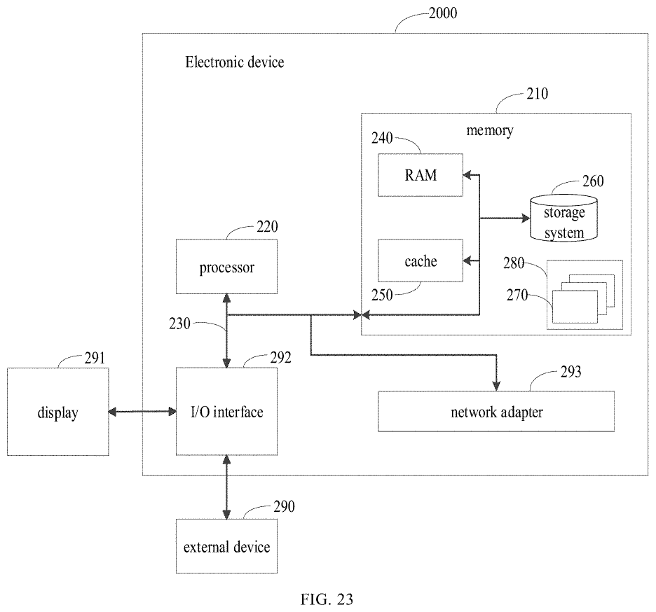

As an example, FIG. 23 is a schematic diagram of an electronic device according to an embodiment. As illustrated in FIG. 23, the electronic device 2000 may include a memory 210, a processor 220 and a bus 230.

The bus 230 is configured to connect various components, including the memory 210 and the processor 220. The memory 210 stores a computer program. The method for aggregating notification messages described in this disclosure is implemented when the processor 220 executes the program.

The bus 230 represents one or more of several bus structures, including a memory bus or memory controller, a peripheral bus, a graphics acceleration port, a processor, or a local bus that uses any of the bus structures in a variety of bus structures. For example, these architectures include, but are not limited to, the Industry Standard Architecture (ISA) bus, the Microchannel Architecture (MAC) bus, the Enhanced ISA bus, the Video Electronic Standards Association (VESA) Local area bus, and the Peripheral Component Interconnection (PCI) bus.

The electronic device 2000 typically includes a variety of electronic device readable media. These media may be any available media that can be accessed by the electronic device 2000, including volatile and non-volatile media, removable and immovable media.

The memory 210 may also include computer readable media in the form of volatile memory, such as random access memory (RAM) 240 and/or cache 250. The electronic device 2000 may further include other removable/non-removable, volatile/non-volatile computer storage media. As an example only, the storage system 260 may be used to read and write non-removable, non-volatile magnetic media (not shown in FIG. 23, often referred to as a “hard drive”). Although not shown in FIG. 23, disk drives may be provided for reading and writing to removable nonvolatile disks (such as “floppy disks”), as well as CD-ROM drives for reading and writing to removable nonvolatile disks (such as CD-ROM, DVD-ROM, or other optical media). In these cases, each drive may be connected to the bus 230 through one or more data media interfaces. The memory 210 may include at least one program product having a set (for example, at least one) of program modules configured to perform the functions of the embodiments of this disclosure.

The program/utility tool 280 having a set (at least one) of program modules 270 may be stored in the memory 210. For example, such program modules 270 include, but not limited to, the operating system, one or more applications, other program modules and program data, and each one or some combination of these examples may include the implementation of the network environment. The program modules 270 normally perform the functions and/or methods in the embodiments described in this disclosure.

The electronic device 2000 may also communicate with one or more external devices (such as a keyboard, pointing device, display 291), and may also communicate with one or more devices that enable users to interact with the electronic device 2000, and/or communicate with any device that enables the electronic device 2000 to communicate with one or more other computing devices (such as network cards, modems, etc.). This communication may be done through the input/output (I/O) interface 292. In addition, the electronic device 2000 may communicate with one or more networks (such as local area network (LAN), wide area network (WAN) and/or public networks, such as the Internet) through the network adapter 293. As shown in the figure, the network adapter 293 communicates with the other modules of the electronic device 2000 through the bus 230. It should be understood that, although not shown in FIG. 23, additional hardware and/or software modules may be used with the electronic device 2000, including but not limited to: microcode, device drives, redundant processing units, external disk drive arrays, RAID systems, tape drives, and data backup storage systems.

The processor 220 performs functional applications and data processing by running programs stored in the memory 210.

It is to be noted that the implementation process and technical principles of the electronic device in this embodiment are described in the above explanation of the method for aggregating notification messages in this disclosure and will not be repeated here.

In this disclosure, the highly correlated notification messages belonging to the same task are aggregated and displayed, so that users no longer rely on search to obtain the relevant notification messages from the massive and scattered notification messages, ensuring that users can quickly view the relevant notification messages of the same task, reducing the time consumed by viewing notification messages, and improving the efficiency of viewing messages.

For the implementation of the above embodiments, this disclosure provides a computer readable storage medium that enables the electronic device to perform the notification message aggregation method described in the above embodiments when the instructions in the computer readable storage medium are executed by the processor of the electronic device.

For the implementation of the above embodiments, this disclosure provides a computer program product that enables the electronic device to perform the method for aggregating notification messages described in the embodiments when the instructions in the computer program product are executed by the processor of the electronic device.

What is claimed is:

1. A method for aggregating notification messages, comprising:
receiving at least one notification message;
obtaining a task identifier of a task to which each notification message belongs;
obtaining notification messages belonging to a same task based on the task identifiers; and
aggregating and displaying the notification messages belonging to the same task.

2. The method of claim 1, wherein aggregating and displaying the notification messages belonging to the same task comprises:
aggregating the notification messages belonging to the same task into a message display box of the task for display.

3. The method of claim 2, wherein aggregating the notification messages belonging to the same task into the message display box of the task for display comprises:
displaying an allowable number of notification messages belonging to the same task in a display area of the message display box, in response to a total number of the notification messages belonging to the same task being greater than the allowable number.

4. The method of claim 3, wherein aggregating the notification messages belonging to the same task into the message display box of the task for display comprises:
hiding and displaying remaining notification messages belonging to the same task in the message display box outside the display area, and displaying a message display control in the message display box.

5. The method of claim 4, further comprising:
in response to a first trigger operation on the message display control, adjusting a display size of the display area of the message display box, and displaying the hidden notification messages in the display area of the message display box.

6. The method of claim 4, further comprising:
in response to a second trigger operation on the message display control, recovering the display area of the message display box to the default display size, and hiding the previously hidden notification messages again.

7. The method of claim 2, further comprising:
obtaining a latest notification time of each task, wherein the latest notification time of the task is a notification time of a latest notification message for the task;
determining a display order of the message display box of each task in the display interface according to the latest notification time of each task from late to early, and displaying the message display box of each task in the display interface according to the display order.

8. The method of claim 7, further comprising:
determining a target task to which a new notification message belongs,
displaying the message display box of the target task at the first place of the display interface.

9. The method of claim 2, further comprising:
in response to the message display box being in an unconcerned state and detecting a click operation on a task concern control in the message display box, updating the task corresponding to the message display box as a concerned state, and displaying a concerned icon on the task concern control.

10. The method of claim 2, further comprising:
in response to the message display box being in a concerned state and detecting a click operation on the task concern control in the message display box, updating the task corresponding to the message display box as a concern cancelled state, and displaying a concern cancelled icon on the task concern control.

11. The method of claim 2, further comprising:
in response to detecting a close or refresh operation on the message display box of the task the concern of which is cancelled, removing the message display box of the task the concern of which is cancelled from the display interface.

12. The method of claim 2, further comprising:
in response to detecting a renewed concern operation on the task the concern of which is cancelled, re-displaying the message display box of the task the concern of which is cancelled in the display interface.

13. The method of claim 2, further comprising:
in response to detecting a reading operation for the notification message is detected, determining a read notification message;
determining a message type of the read notification message;
in response to the message type indicating that the read notification message is a viewing message, removing the read notification message from the message display box and adding the read notification message into a history message queue; or
in response to the message type indicating that the read notification message is an interaction message, and in response to not detecting an interaction operation indicated by the read notification message, updating a state of the read notification message as a read state, and keeping displaying the read notification message in the message display box.

14. The method of claim 1, further comprising:
in response to the notification message being a non-task message, displaying the notification message in the display interface separately.

15. The method claim 1, further comprising:
in response to the notification message being a task message, obtaining the task identifier of the notification message.

16. The method of claim 2, wherein aggregating the notification messages belonging to the same task into the message display box of the task for display comprises:
displaying the notification message belonging to the same task in the message display box of the task according to a notification time from late to early.

17. An electronic device, comprising:
a processor; and
a memory, configured to store instructions executable by the processor;
wherein the processor is configured to read and execute the instructions stored in the memory to perform operations of:
receiving at least one notification message;
obtaining a task identifier of a task to which each notification message belongs;
obtaining notification messages belonging to a same task based on the task identifiers; and
aggregating and displaying the notification messages belonging to the same task.

18. A non-transitory computer readable storage medium, stored thereon with instructions that, when executed by a processor of an electronic device, cause the electronic device to implement a method for aggregating notification messages, the method comprising:
receiving at least one notification message;
obtaining a task identifier of a task to which each notification message belongs;
obtaining notification messages belonging to a same task based on the task identifiers; and
aggregating and displaying the notification messages belonging to the same task.
